(19) United States
(12) Patent Application Publication
(10) Pub. No.: US 2010/0124335 A1
(43) Pub. Date: May 20, 2010

(54) Scoring a match of two audio tracks sets using track time probability distribution

(75) Inventors: Jens Nicholas Wessling, Ann Arbor, MI (US); Dustin James Williams, Dexter, MI (US)

Correspondence Address: PATENT DEPARTMENT;ROVI CORPORATION, 2830 DE LA CRUZ BOULEVARD, SANTA CLARA, CA, 95050, US

(73) Assignee: All Media Guide, LLC

(21) Appl. No.: 12/313,324

(22) Filed: Nov. 19, 2008

(51) Int. Cl. H04R 29/00

(52) U.S. Cl. 381/56

(57) ABSTRACT

A method and a system are provided for scoring a match of two audio tracks sets using a track time probability distribution. In one example, the system receives the two audio tracks sets, including a first audio tracks set and a second audio tracks set. Next, the system extracts track times of the first audio tracks set and corresponding track times of the second audio tracks set. The system then calculates a total weighted score of the match of the two audio tracks set, wherein the total weighted score is based on a track time probability distribution and a comparison between the track times of the first audio tracks set and the corresponding track times of the second audio tracks set.

### FIELD OF THE INVENTION

The present invention relates to techniques for determining if two sets of audio tracks are a sufficient match. More particularly, the present invention relates to techniques for recognizing standard collections of audio tracks such as the ones found on audio compact discs, audio DVDs or their digitized versions, and providing additional information to the user regarding these tracks.

### BACKGROUND

Methods exist for reading table of contents (TOC) data from compact discs (CDs) and using the data to lookup information in databases or to monitor and control the playback of a compact disc. U.S. Pat. Nos. 6,230,192 and 6,330,593 (“the '192 and '593 patents”) provide conventional examples of such methods. The '192 and the '593 patents relate generally to delivering supplemental entertainment content to a user listening to a musical recording. The content is accessed using a Web browser, which is able to control and monitor playback of the recording. Using conventional techniques, an identifier is computed for the CD being played. The identifier may be determined based on the number and lengths of tracks on the CD.

### SUMMARY

Conventional systems typically use an identifier to retrieve information from a database relating to the recordings played by the user. Specifically, the identifier is computed upon detection of a disc in the CD player of the user's computer and sent to a remote server hosting a Web site containing information about the CDs produced by a particular record company. The server uses the identifier as a key to lookup a single matching record in a database and outputs the information stored in that matching record.

Unfortunately, there are disadvantages of these conventional systems because they do not account for the following: differences in track times that may occur in different releases or pressings of CDs of the same recording; certain reading software rounding up on track time, with other reading software rounding down on track time, causing discrepancies in track time comparing; a user ripping a track to hard disk and then ripping the song back to CD, causing a probable time shift; various CD burning software altering track time. These track time differences on one CD could easily add up to cause a conventional system to be inaccurate and unreliable. The result may be an identifier being computed that does not match the identifier stored in the database, which in turn might prevent retrieval of the data relating to the recording.

Fuzzy TOC is another method of identifying a CD. The '192 and '593 patents introduce the concept of a “fuzzy comparison algorithm” for determining whether two CDs are the same. The algorithm involves truncating track lengths obtained from TOC data and summing the total track time and track time differences between two CDs. These values are then used to determine a percentage that is “indicative of how well the two CDs match.” If it is used to find a match between a CD being played and an entry in a database, then such an approach has at least two disadvantages. First, this calculation would have to be performed for each and every entry in the database to find a single matching record, which would be extremely inefficient. Second, the truncation of the track lengths raises the possibility that two CDs might yield the same truncated track lengths and be identified as a match. Or, as discussed above, two different pressings or releases of the same CD might yield different truncated track lengths and therefore would not be identified as a match. In either case, a correct matching record in the database would not be found.

Accordingly, these approaches suffer from a number of disadvantages. These conventional methods are predicated on computing a single identifier for a recording and looking up information in a database containing potentially several matching records.

What is needed is an improved method having features for addressing the problems mentioned above and new features not yet discussed. Broadly speaking, the present invention fills these needs by providing a method and a system for scoring a match of two audio tracks sets using a track time probability distribution. It should be appreciated that the present invention can be implemented in numerous ways, including as a method, a process, an apparatus, a system or a device. Inventive embodiments of the present invention are summarized below.

In one embodiment, a method is provided for scoring a match of two audio tracks sets. The method comprises receiving the two audio tracks sets, including a first audio tracks set and a second audio tracks set; extracting track times of the first audio tracks set and corresponding track times of the second audio tracks set; and calculating a total weighted score of the match of the two audio tracks set, wherein the total weighted score is based on a track time probability distribution and a comparison between the track times of the first audio tracks set and the corresponding track times of the second audio tracks set.

In another embodiment, a system is provided for scoring a match of two audio tracks sets. The system is configured for receiving the two audio tracks sets, including a first audio tracks set and a second audio tracks set; extracting track times of the first audio tracks set and corresponding track times of the second audio tracks set; and calculating a total weighted score of the match of the two audio tracks set, wherein the total weighted score is based on a track time probability distribution and a comparison between the track times of the first audio tracks set and the corresponding track times of the second audio tracks set.

In still another embodiment, a computer readable medium is provided carrying one or more instructions for scoring a match of two audio tracks sets. The one or more instructions, when executed by one or more processors, cause the one or more processors to perform the steps of receiving the two audio tracks sets, including a first audio tracks set and a second audio tracks set; extracting track times of the first audio tracks set and corresponding track times of the second audio tracks set; and calculating a total weighted score of the match of the two audio tracks set, wherein the total weighted score is based on a track time probability distribution and a comparison between the track times of the first audio tracks set and the corresponding track times of the second audio tracks set.

The invention encompasses other embodiments configured as set forth above and with other features and alternatives.

### BRIEF DESCRIPTION OF THE DRAWINGS

The present invention will be readily understood by the following detailed description in conjunction with the accompanying drawings. To facilitate this description, like reference numerals designate like structural elements.

FIG. 1 is a block diagram of a system for scoring a match of two audio tracks sets using a track time probability distribution, in accordance with an embodiment of the present invention;

FIG. 2 is a block diagram of an alternative system for scoring a match of two audio tracks sets using a track time probability distribution, in accordance with an embodiment of the present invention;

FIG. 3 is a graph illustrating a track time probability distribution over a sample set that is intended to represent many music genres, in accordance with an embodiment of the present invention;

FIG. 4 is a graph illustrating a track time probability distribution over a sample set that is intended to represent the music genre of jazz, in accordance with an embodiment of the present invention; and

FIG. 5 is a flowchart of a method for scoring a match of two audio tracks sets using a track time probability distribution, in accordance with an embodiment of the present invention.

### DETAILED DESCRIPTION

An invention is disclosed for a method and a system for scoring a match of two audio tracks sets using a track time probability distribution. Numerous specific details are set forth in order to provide a thorough understanding of the present invention. It will be understood, however, to one skilled in the art, that the present invention may be practiced with other specific details.

### Definitions

Some terms are defined below for clarity purposes. These terms are not rigidly restricted to these definitions. These terms and other terms may also be defined by their use in the context of this description.

“Computer” may refer to a single computer or to a system of interacting computers. A computer is a combination of a hardware system, a software operating system and perhaps one or more software application programs. Examples of a computer include without limitation a laptop computer, a palmtop computer, a smart phone, a cell phone, a mobile phone, an mp3 player, an IBM-type personal computer (PC) having an operating system such as Microsoft Windows®, an Apple® computer having an operating system such as MAC-OS, hardware having a JAVA-OS operating system, and a Sun Microsystems Workstation having a UNIX operating system.

“Device” means hardware, software or a combination thereof. A device may sometimes be referred to as an apparatus. Each device is configured to carry out one or more steps of the method of scoring a match of two audio tracks sets using a track time probability distribution.

“Network” means a connection between any two or more computers, which permits the transmission of data. A network may be any combination of networks, including without limitation the Internet, a local area network, a wide area network, a wireless network and a cellular network.

“Web page” means any documents written in mark-up language including without limitation HTML (hypertext mark-up language) or VRML (virtual reality modeling language), dynamic HTML, XML (extended mark-up language) or related computer languages thereof, as well as to any collection of such documents reachable through one specific Internet address or at one specific Web site, or any document obtainable through a particular URL (Uniform Resource Locator).

“Web site” means at least one Web page, and more commonly a plurality of Web pages, virtually connected to form a coherent group.

“Web browser” means any software program which can display text, graphics, or both, from Web pages on Web sites. Examples of a Web browser include without limitation Mozilla Firefox® and Microsoft Explorer®.

“Web server” refers to a computer or other electronic device which is capable of serving at least one Web page to a Web browser. An example of a Web server is a Yahoo® Web server.

“Metadata” generally means data that describes data. Here, metadata means data that describes the contents of a digital audio recording. Such metadata may include, for example, artist information (e.g., name, birth date, discography, etc.), album information (e.g., title, review, track listing, sound samples, etc.), relational information (e.g., similar artists and albums, genre, etc.), and other types of supplemental information.

For the present invention, a software application could be written in substantially any suitable programming language, which could easily be selected by one of ordinary skill in the art. The programming language chosen should be compatible with the computer by which the software application is to be executed and, in particular, with the operating system of that computer. Examples of suitable programming languages include without limitation Object Pascal, C, C++, CGI, Java and Java Scripts. Further, the functions of the present invention, when described as a series of steps for a method, could be implemented as a series of software instructions for being operated by a processor, such that the present invention could be implemented as software, hardware, or a combination thereof.

### General Overview

The present system is configured for, among other things, extracting track duration data from a collection of audio tracks stored on a compact disc (CD). Alternatively, the system may read track durations directly from a collection of audio files (e.g., an album that has been digitized and stored on a computer using an audio player). The system may then use the track duration data, which includes information regarding the length of each track and the number of tracks into which a album is divided, to look up information about the audio recording, such as the title and artist, in a database storing such data.

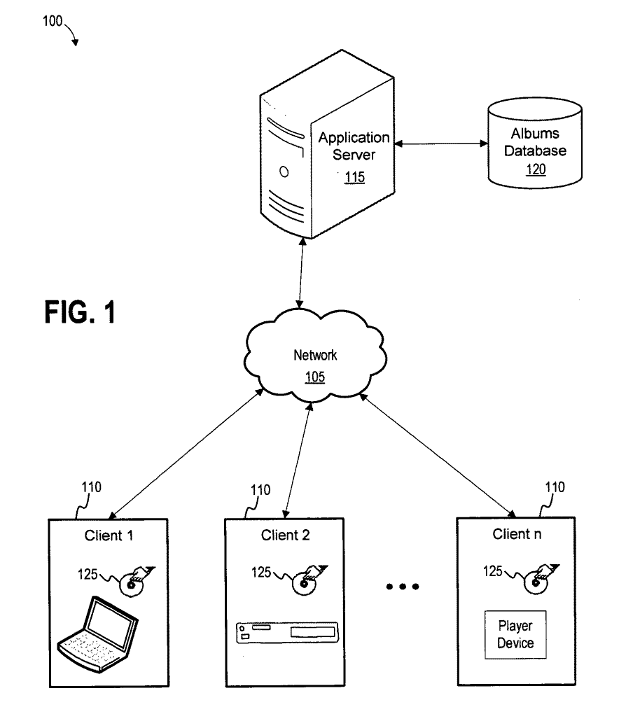

FIG. 1 is a block diagram of a system 100 for scoring a match of two audio tracks sets using a track time probability distribution, in accordance with an embodiment of the present invention. A network 105 is coupled to an application server 115. The application server 115 is coupled to (or includes) a albums database 120 that holds track duration data and information relating to digital audio recordings. The network 105 is also coupled to a number of client devices 110, Client 1 through Client n, that are configured to read digital audio recordings and associated track duration data from media, such as compact discs (CD) or local hard drives. The client devices are also configured to send the track duration data to the application server 115 to retrieve information relating to the recording. The client devices may be for example a personal computer (Client 1), a component CD player (Client 2) or another player device (Client n). Other possibilities for client devices 110 exist as well.

Each client device 110 has hardware and/or software for communicating with the application server 115. For example, a client device 110 may have an operating system with a graphical user interface (GUI) to access the Internet and is preferably equipped with graphical World Wide Web (Web) browser software, such as Mozilla Firefox®, operable to read and send Hypertext Markup Language (HTML) forms from and to a Hypertext Transport Protocol (HTTP) server on the Web. Client CD players may have built-in interfaces that enable them to communicate with the application server 115 via the network 105, either directly or through a computer. For example, a CD player may have a data interface, such as a RS-232 or a USB interface, that enables the CD player to send and receive data from a computer, which in turn is coupled to the network 105.

Likewise, the application server 115 includes hardware and software for communicating with the clients 110. For example, the application server 115 may have HTTP compliant software, an operating system and common gateway interface (CGI) software for interfacing with clients 110 via the network 105. Alternatively, the application server 115 and clients 110 may run proprietary software that enables them to communicate via the network 105.

It will be readily appreciated that the schematic of FIG. 1 is exemplary only, and that numerous variations are clearly possible. For example, the application server 115 may be connected to a local area network (LAN), which in turn may be connected to the network 105. The application server 115 may also be coupled to multiple Web servers.

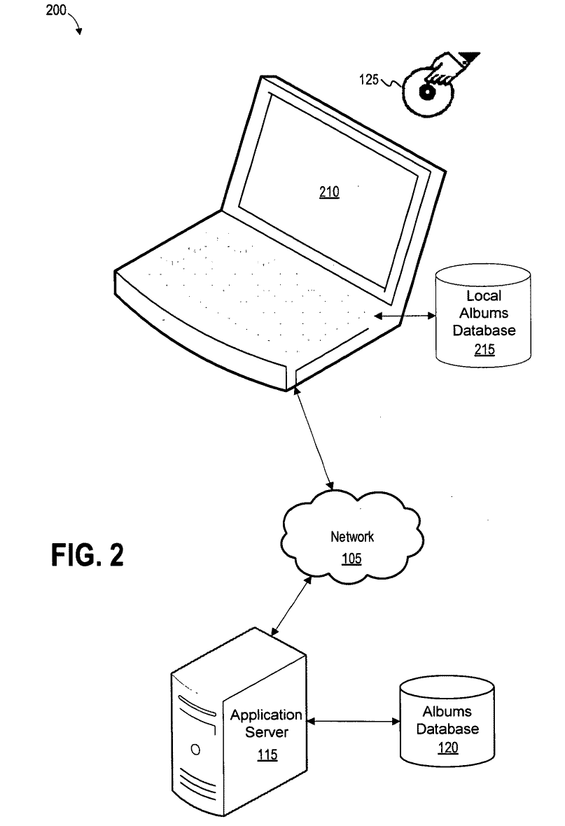

FIG. 2 is a block diagram of an alternative system 200 for scoring a match of two audio tracks sets using a track time probability distribution, in accordance with an embodiment of the present invention. This system 200 is implemented by using a user computer 210 without the client-server architecture discussed with reference to FIG. 1. The user computer 210 is configured to be operated by a user. The user computer 210 may be coupled to the network 105. However, the coupling to the network 105 is optional. All software and data necessary for carrying out the present method may be stored on a local storage device associated with the digital audio playback device. For example, the user computer 210 has a CD drive (not shown) to playback digital audio of a compact disc 125. The user computer 210 also may have stored a local albums database 215, containing a complete set or a subset of the information available in the corresponding albums database 120 coupled to the application server 115. The user computer 210 may load the local albums database 215 from a CD-ROM (not shown) onto the hard disk of the user computer 210. Alternatively, the user computer 210 may download the local albums database 215 from the albums database 120 via the network 105. For example, the user computer 210 may download the albums database 120 from a Web site via the network 105. Other variations exist as well.

The system 200 preferably derives track duration data from TOC data for a digital audio recording, such as a CD. TOC data is stored on a CD using a format specified in the “Red Book” (Compact Disc Digital Audio System Description, Philips Corporation, May 1999), which provides the standards for digital audio CDs. The TOC data consists of a string of concatenated track start times for every track on the disc, expressed as six-digit hexadecimal values.

### Scoring a Match of Two Audio Tracks Sets

The present system provides a weighted score between two sets of audio tracks to determine the likelihood of a sufficient match between the two sets of audio tracks. For example, when trying to find a sufficient match between a CD and a catalog of CDs, the system creates a TOC for each CD based on the durations of each track. This system also provides an improvement on how a TOC of two particular CDs are scored against each other to find the optimal match. This improvement involves using the probability of a track being a certain length in order to weight the difference between the two track times. More common times are weighted less than rarer track times. The system compares multiple tracks between two CDs. The result of comparing multiple tracks is an overall weighted score that provides an accurate determination of a sufficient match, or insufficient match, between the two CDs.

It is important to note that a CD is used here as an example for explanatory purposes. A CD is a common storage medium on which to store a set of audio tracks. However, the present system is not limited to scoring audio tracks on CD's only. The system may be applied when any two sets of audio tracks are to be scored against one another, no matter the particular storage medium. For example, the particular storage medium may be DVD, hard disk or flash memory, among other storage mediums. Further, music tracks are used below for explanatory purposes. However, the present system is not limited to comparing music tracks. The system may compare any two sets of audio tracks. For example, the system may compare two audio DVDs having audio tracks.

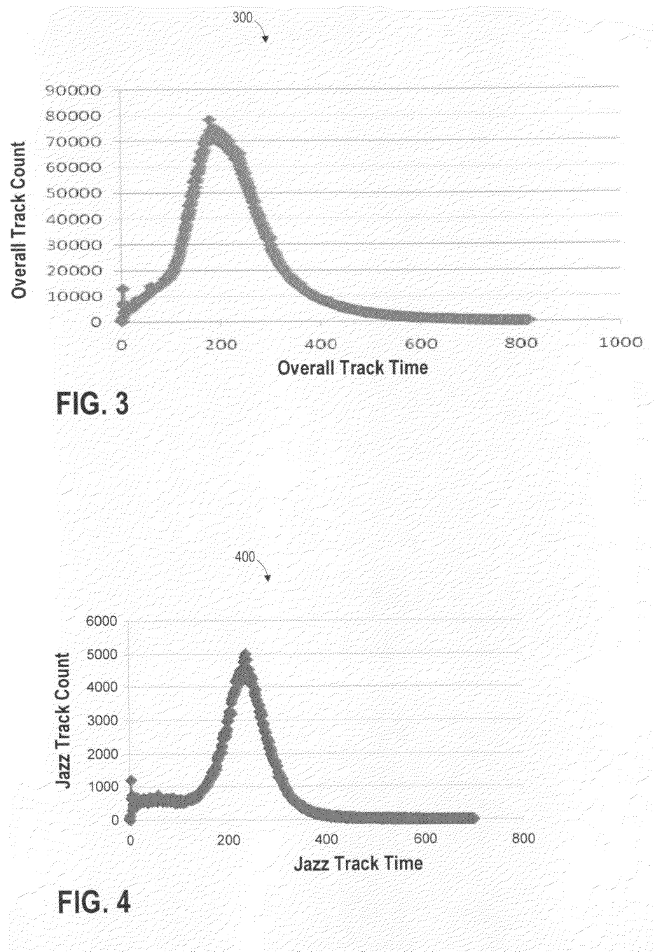

FIG. 3 is a graph 300 illustrating a track time probability distribution over a sample set that is intended to represent many music genres (or effectively no genre), in accordance with an embodiment of the present invention. This graph 300 is a track time probability distribution across a large number of tracks. In this graph 300, tracks with duration of about 200 seconds tend to be the most common. It is easy to see that tracks with duration of about 200 seconds are substantially more common than tracks with times greater than about 400 seconds or less than about 50 seconds.

Tracks with rarer times in the graph 300 are more valuable in determining a match between two CDs. For the graph 300 of FIG. 3, the weight that may be assigned to a particular track time is inversely related to the track count associated with that particular track time. For example, a weight may be given by the following equation:

$$Weight = \frac{15 \text{,} 000}{Track Count} . \qquad Equation 1$$

Equation 1 is provided here for explanatory purposes; the present system may use another suitable equation for the weight.

Using the example of Equation 1, the system would determine the track count by referring to a time probability distribution graph (e.g., graph 300 of FIG. 3) and reading the track count associated with the particular track time of the particular track. The system may then calculate the weight by inserting the track count into Equation 1. Accordingly, if a CD happens to have a track with a rare track time, then that particular track would be a stronger indicator of overall matching CDs than would be a track with a more common track time. In other words, tracks with rarer times (e.g., greater than about 400 seconds or less than about 50 seconds in FIG. 3) are given relatively more weight than tracks with a more common time (e.g., about 200 seconds in FIG. 3).

For even more accuracy, if the system is able to identify the genre of the particular track or the particular album being compared, the system could use such identification to help create an even more accurate track time probability distribution to use for scoring. A genre-specific track time probability distribution would be focused into a particular genre, as opposed to being spread broadly over multiple genres like in FIG. 3, thereby providing more accuracy.

FIG. 4 is a graph 400 illustrating a track time probability distribution over a sample set that is intended to represent the music genre of jazz, in accordance with an embodiment of the present invention. The system may use the graph 400 of FIG. 4 if the system is able to identify the genre of the particular track or particular album as being jazz. The system may be able to identify the genre by analyzing, for example, metadata that may be associated with the particular track.

This graph 400 is a track time probability distribution for the jazz genre specifically. In this graph 400, jazz tracks with duration of about 225 seconds tend to be the most common within the jazz genre. It is easy to see that jazz tracks with duration of about 225 seconds are substantially more common than jazz tracks with durations greater than about 350 seconds or less than about 150 seconds.

The jazz tracks with rarer times of the graph 400 are more valuable in determining a match between two CDs. For the graph 400 of FIG. 4, the weight that may be assigned to a particular jazz track time is inversely related to the track count associated with that particular jazz track time. Accordingly, if a CD to be compared happens to have a jazz track with a rare track time, then that particular jazz track would be a stronger indicator of overall matching CDs than would be a track with a more common jazz track time. In other words, jazz tracks with rarer times (e.g., greater than about 350 seconds or less than about 150 seconds in FIG. 4) are given more weight than jazz tracks with a more common time (e.g., about 225 seconds in FIG. 4).

Note that the jazz genre is used in FIG. 4 for explanatory purposes. However, the system is not limited to jazz. The system may focus on any genre for which the system has stored a track time probability distribution. Referring to FIG. 1, the system 100 may store the various track time probability distributions in the albums database 120 or another suitable database. Referring to FIG. 2, the system 200 may store the various track time probability distributions in the local albums database 215 or another suitable database.

Referring to FIG. 3, consider a comparison between two CDs, CD1 and CD2. Each CD has 7 tracks. The system extracts from the TOC of each CD the time for each track. The comparison of the two CDs is illustrated in the following Table:

TABLE 1
TOC scoring comparison between two CDs

| | | | | | Weighted | Un-weighted |
|---|---|---|---|---|---|---|
| | | | | | Score | Score |
| | | | | | (Present | (Conventional |
| Track | CD1 | CD2 | Delta | Weight | System) | System) |
| 1 | 225 | 215 | 10 | 0.23 | 2.3 | 4.21 |
| 2 | 108 | 110 | 2 | 0.71 | 1.42 | 0.84 |
| 3 | 188 | 199 | 11 | 0.22 | 2.42 | 4.64 |
| 4 | 334 | 336 | 2 | 0.55 | 1.1 | 0.84 |
| 5 | 409 | 400 | 9 | 0.76 | 6.84 | 3.79 |
| 6 | 222 | 214 | 8 | 0.26 | 2.08 | 3.37 |
| 7 | 199 | 202 | 3 | 0.22 | 0.66 | 1.26 |
| | | | | Total | 16.82 | 18.96 |

In Table 1, the “Track” column provides the track number being compared. The “CD1” column provides the duration (seconds) for the particular track of CD1. The “CD2” column provides the duration (seconds) for the particular track of CD2. The “Delta” column provides the time difference (seconds) between the corresponding tracks of CD1 and CD2. The “Weights” column provides the relative weight of the particular track for scoring purposes.

The “Weighted Score” column provides the results of the present system. Here, a weighted score is the product of Delta times the weight for the particular track. For this example of Table 1, a weighted score may be given by the following equation:

Weighted Score=Delta×Weight. Equation 2.

This Equation 2 is provided here for explanatory purposes; the present system may use another suitable equation for the weighted score.

The “Un-weighted Score” column provides the results of a conventional system. An un-weighted score is an un-weighted scaling of the particular time difference between two compared tracks. An un-weighted score may be the product of Delta times some coefficient. For this example of Table 1, an un-weighted score is given by the following equation:

Un-weighted Score=Delta×0.4214. Equation 3.

This Equation 3 is provided here for explanatory purposes; a conventional system may use another suitable equation for the un-weighted score.

The “Totals” row at the bottom of Table 1 provides the sum of the weighted scores and the sum of the un-weighted scores. Here, the sum of the weighted scores is 16.82; the sum of the un-weighted scores is 18.96.

Regarding the weights, more common times are weighted less than rarer track times. Referring to Track 1 of CD2, the track time of 215 seconds is a relatively common time according to FIG. 3; accordingly, the system assigns to Track 1 a relatively low weight of 0.23. Referring to Track 2 of CD2, the track time of 110 seconds is a relatively rare time according to FIG. 3; accordingly, the system assigns to Track 2 a relatively high weight of 0.71. Referring to Track 3 of CD2, the track time of 199 seconds is a relatively common time according to FIG. 3; accordingly, the system assigns to Track 3 a relatively low weight of 0.22. Referring to Track 4 of CD2, the track time of 336 seconds is a relatively rare time according to FIG. 3; accordingly, the system assigns to Track 4 a relatively high weight of 0.55. Referring to Track 5 of CD2, the track time of 400 seconds is a relatively rare time according to FIG. 3; accordingly, the system assigns to Track 5 a relatively high weight of 0.76. Referring to Track 6 of CD2, the track time of 214 seconds is a relatively common time according to FIG. 3; accordingly, the system assigns to Track 6 a relatively low weight of 0.26. Referring to Track 7 of CD2, the track time of 202 seconds is a relatively common time according to FIG. 3; accordingly, the system assigns to Track 7 a relatively low weight of 0.22.

Here, the system uses CD2 as the basis for assigning the weights in Table 1. However, the system is not so limited. In another embodiment, the system may use CD 1 as the basis for assigning the weights. In still another embodiment, the system may use some combination of CD1 and CD2, perhaps an average time between two compared tracks, to form the basis for assigning the weights.

Lower scores (weighted and un-weighted) represent a stronger relative match. In another embodiment, higher scores may represent a stronger relative match, depending on how the system is designed. In still another embodiment, a higher weight may mean a track has less relative importance, while a lower weight may mean a track has more relative importance, depending on how the system is designed. The actual scores and weights are not as important as the defined relationships between the various scores and weights. A designer of the system may define these relationships in a multitude of different ways. Equations 1-3 provide examples of how a designer may define the relationships between the weights and scores.

Notice a significant difference between the weighted scores and the un-weighted scores in Table 1. A conventional system does not take into a consideration a track time probability distribution like that of FIG. 3 or FIG. 4. Consequently, the un-weighted score results from conventional systems are significantly less reliable than the weighted score results from the present system. The comparison in Table 1 shows that the overall un-weighted score of 18.96 indicates these two CDs are less similar than does the overall weighted score of 16.82. A different comparison between two other CDs may result in a greater or lesser difference between the total scores (weighted versus un-weighted). As mentioned above, lower scores in Table 1 represent a stronger relative match. The un-weighted scores here may indicate a non-match; however, the weighted scores here may indicate a match. In light of the fact that un-weighted scores are less reliable, the un-weighted scores may be indicating a false non-match. Regardless of what the un-weighted score of a conventional system may indicate, the weighted score of the present system is more reliable.

Referring to FIG. 1, if the application server 115 determines that two CDs are a sufficient match, the application server 115 retrieves from the albums database 120 the metadata associated with the matching CD. The application then sends this metadata to the client computer 110. After receiving a response from the application server 115, the client computer 110 may display the returned metadata or a “no match” screen, as appropriate. The client computer 110 may take other actions as well.

Referring to FIG. 2, if the user computer 210 determines that two CDs are a sufficient match, the user computer 210 reads from the local albums database 215 to get the metadata associated with the matching CD. The user computer 210 may then display the metadata or a “no match” screen, as appropriate. The user computer 210 may take other actions as well.

### Method Overview

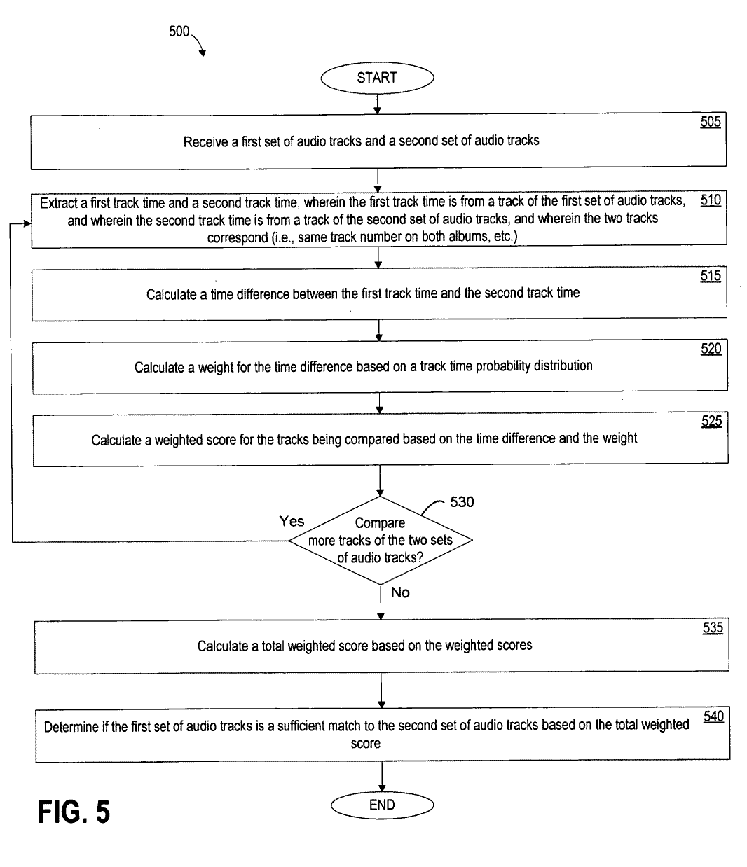

FIG. 5 is a flowchart of a method 500 for scoring a match of two audio tracks sets using a track time probability distribution, in accordance with an embodiment of the present invention. In some embodiments, the steps of the method 500 may be carried out by the application server 115 of FIG. 1 or the user computer 210 of FIG. 2.

The method 500 starts in step 505 where the system receives a first set of audio tracks and a second set of audio tracks. The method 500 then moves to step 510 where the system extracts a first track time and a second track time; the first track time is from a track of the first set of audio tracks; the second track time is from a track of the second set of audio tracks; the two tracks correspond (i.e., same track number on both albums, etc.). Next, in step 515, the system calculates a time difference between the first track time and the second track time. The method 500 then proceeds to step 520 where the system calculates a weight for the time difference based on a track time probability distribution. Then, in step 525, the system calculates a weighted score for the tracks being compared based on the time difference and the weight.

Next, in decision operation 530, the system determines if more tracks of the two sets of audio tracks are to be compared. If more tracks are to be compared, then the system returns to step 510 and continues. However, if the system determines that no more tracks are to be compared, then the method 500 moves to step 535 where the system calculates a total weighted score based on the individual weighted scores. This total weighted score may be a sum of the individual weighted scores, as discussed above with reference to Table 1. The method 500 then proceeds to step 540 where the system determines if the first set of audio tracks is a sufficient match to the second set of audio tracks based on the total weighted score. The method 500 is then at an end.

Note that the present method may include other details and steps that are not discussed in this method overview. For example, if the system determines that the sets of audio tracks are a sufficient match, then the system may look up the appropriate metadata associated with the sets of audio tracks and send that metadata to a user computer. Other details and steps are discussed above with reference to the appropriate figures and may be a part of the present method, depending on the embodiment.

### Computer Readable Medium Implementation

Portions of the present invention may be conveniently implemented by using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The invention may also be implemented by the preparation of application-specific integrated circuits or by interconnecting an appropriate network of conventional component circuits, as will be readily apparent to those skilled in the art.

The present invention includes a computer program product which is a storage medium (media) having instructions stored thereon/in which can be used to control, or cause, a computer to perform any of the processes of the present invention. The storage medium can include without limitation any type of disk including floppy disks, mini disks (MD's), optical disks, DVDs, CD-ROMs, micro-drives, and magneto-optical disks, ROMs, RAMs, EPROMs, EEPROMs, DRAMs, VRAMs, flash memory devices (including flash cards), magnetic or optical cards, nanosystems (including molecular memory ICs), RAID devices, remote data storage/archive/warehousing, or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include without limitation device drivers, operating systems, and user applications. Ultimately, such computer readable media further includes software for performing the present invention, as described above.

Included in the programming (software) of the general/specialized computer or microprocessor are software modules for implementing the teachings of the present invention, including without limitation receiving the two audio tracks sets, including a first audio tracks set and a second audio tracks set; extracting track times of the first audio tracks set and corresponding track times of the second audio tracks set; and calculating a total weighted score of the match of the two audio tracks set, wherein the total weighted score is based on a track time probability distribution and a comparison between the track times of the first audio tracks set and the corresponding track times of the second audio tracks set, according to processes of the present invention.

### Advantages

The weighted scoring provided by the embodiments described herein is substantially more reliable then the un-weighted scoring provided by a conventional system. The weighted scoring takes into account the importance of the particular track comparison. Tracks that are rarer are given more weight in the process of trying to figure out if two sets of audio tracks are a match. Tracks that are more common are given less weight in the process of trying to figure out if two sets of audio tracks are a match. Accordingly, the overall weighted score takes into account the variations of the different weights. Thus, this weighted scoring mechanism is substantially more reliable and more accurate than an un-weighted scoring mechanism.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A method for scoring a match of two audio tracks sets, the method comprising:
receiving the two audio tracks sets, including a first audio tracks set and a second audio tracks set;
extracting track times of the first audio tracks set and corresponding track times of the second audio tracks set; and
calculating a total weighted score of the match of the two audio tracks set, wherein the total weighted score is based on a track time probability distribution and a comparison between the track times of the first audio tracks set and the corresponding track times of the second audio tracks set.

2. The method of claim 1, wherein the calculating a total weighted score comprises at least one of:
calculating time differences between the track times of the first audio tracks set and the corresponding track times of the second audio tracks set; and
calculating weights for the time differences based on the track time probability distribution.

3. The method of claim 2, wherein each weight is inversely related to a probability of a particular track time occurring.

4. The method of claim 2, further comprising setting each weight based on a degree of rarity of a track time of the particular track comparison according to the track time probability distribution.

5. The method of claim 2, further comprising at least one of:
assigning relatively more weight to a particular track comparison if a track of the particular track comparison has a relatively rare time according to the track time probability distribution; and
assigning relatively less weight to a particular track comparison if a track of the particular track comparison has a relatively common time according to the track time probability distribution.

6. The method of claim 1, wherein the track time probability distribution is representative of at least one of:
many genres;
one particular genre; and
no genre.

7. The method of claim 1, further comprising at least one of:
determining a particular genre of a particular track being compared; and
using a track time probability distribution that is representative of the particular genre.

8. The method of claim 1, further comprising at least one of:
determining that the first audio tracks set is a sufficient match to the second audio tracks set;
retrieving metadata for the sufficient match from a albums database; and
sending the metadata to a user computer.

9. The method of claim 1, further comprising at least one of:
determining that the first audio tracks set is a sufficient match to the second audio tracks set;
retrieving metadata for the sufficient match from a local albums database of a user computer; and
displaying the metadata on the user computer.

10. The method of claim 1, wherein the extracting the track times comprises at least one of:
reading from a table of contents of the first audio tracks set; and
reading from a table of contents of the second audio tracks set.

11. A system for scoring a match of two audio tracks sets, wherein the system is configured for:
receiving the two audio tracks sets, including a first audio tracks set and a second audio tracks set;
extracting track times of the first audio tracks set and corresponding track times of the second audio tracks set; and
calculating a total weighted score of the match of the two audio tracks set, wherein the total weighted score is based on a track time probability distribution and a comparison between the track times of the first audio tracks set and the corresponding track times of the second audio tracks set.

12. The system of claim 11, wherein the calculating a total weighted score comprises at least one of:
calculating time differences between the track times of the first audio tracks set and the corresponding track times of the second audio tracks set; and
calculating weights for the time differences based on the track time probability distribution.

13. The system of claim 12, wherein each weight is inversely related to a probability of a particular track time occurring.

14. The system of claim 12, wherein the system is further configured for setting each weight based on a degree of rarity of a track time of the particular track comparison according to the track time probability distribution.

15. The system of claim 12, wherein the system is further configured for at least one of:
assigning relatively more weight to a particular track comparison if a track of the particular track comparison has a relatively rare time according to the track time probability distribution; and
assigning relatively less weight to a particular track comparison if a track of the particular track comparison has a relatively common time according to the track time probability distribution.

16. The system of claim 11, wherein the track time probability distribution is representative of at least one of:
many genres;
one particular genre; and
no genre.

17. The system of claim 11, wherein the system is further configured for at least one of:
determining a particular genre of a particular track being compared; and
using a track time probability distribution that is representative of the particular genre.

18. The system of claim 11, wherein the system is further configured for at least one of:
determining that the first audio tracks set is a sufficient match to the second audio tracks set;
retrieving metadata for the sufficient match from a albums database; and
sending the metadata to a user computer.

19. The system of claim 11, wherein the system is further configured for at least one of:
determining that the first audio tracks set is a sufficient match to the second audio tracks set;
retrieving metadata for the sufficient match from a local albums database of a user computer; and
displaying the metadata on the user computer.

20. The system of claim 11, wherein the extracting the track times comprises at least one of:
reading from a table of contents of the first audio tracks set; and
reading from a table of contents of the second audio tracks set.

21. A computer readable medium carrying one or more instructions for scoring a match of two audio tracks sets, wherein the one or more instructions, when executed by one or more processors, cause the one or more processors to perform the steps of:
receiving the two audio tracks sets, including a first audio tracks set and a second audio tracks set;
extracting track times of the first audio tracks set and corresponding track times of the second audio tracks set; and
calculating a total weighted score of the match of the two audio tracks set, wherein the total weighted score is based on a track time probability distribution and a comparison between the track times of the first audio tracks set and the corresponding track times of the second audio tracks set.
